(19) United States
(12) Patent Application Publication
(10) Pub. No.: US 2026/0070611 A1
(43) Pub. Date: Mar. 12, 2026

(54) STEERING APPARATUS

(71) Applicant: Honda Motor Co., Ltd., Tokyo (JP)

(72) Inventor: Shotaro Odate, Tokyo (JP)

(21) Appl. No.: 19/321,805

(22) Filed: Sep. 8, 2025

(30) Foreign Application Priority Data
Sep. 10, 2024 (JP) 2024-155495

(51) Int. Cl. B62D 15/02; B60K 35/28; B62D 1/04

(52) U.S. Cl. CPC B62D 15/021; B60K 35/28; B62D 1/046

(57) ABSTRACT

A steering apparatus includes: a sensor unit configured to detect contact or proximity of a human body in a plurality of detection target regions provided on a steering wheel; and a microprocessor configured to compare an output value of the sensor unit with a determination threshold value to determine whether the steering wheel is being gripped, specify, based on the output value, a water-exposed detection target region among the plurality of detection target regions, and, when the water-exposed detection target region is specified, change the determination threshold value from a first value determined before being specified to a second value different from the first value. The microprocessor determines whether the steering wheel is being gripped by comparing an output value of a sensor unit corresponding to a region other than the water-exposed detection target region with the determination threshold value changed to the second value.

### CROSS-REFERENCE TO RELATED APPLICATION

This application is based upon and claims the benefit of priority from Japanese Patent Application No. 2024-155495 filed on September 10, 2024, the content of which is incorporated herein by reference.

### BACKGROUND OF THE INVENTION

### FIELD OF THE INVENTION

The present invention relates to a steering apparatus having a function for detecting whether a driver is gripping a steering wheel.

### DESCRIPTION OF THE RELATED ART

In recent years, efforts to provide access to sustainable transportation systems that take into account people in vulnerable positions among traffic participants have been gaining momentum. In order to achieve this, research and development have been focused on further improving traffic safety and convenience through the research and development regarding driving assistance technologies. In the related art, a device has been known in which a grip/non-grip state is determined by comparing a measurement value of a capacitive sensor provided on the steering wheel with a threshold value (for example, refer to JP 2024-048044 A). In the device disclosed in JP 2024-048044 A, the threshold value is updated in accordance with the difference between a previous value and a current value of the measurement value.

With the device disclosed in JP 2024-048044 A, the threshold value can be updated in response to the temporal changes in the measurement value caused by disturbances such as temperature or humidity. However, since the threshold value is updated on the basis of the difference between the previous value and the current value, there is a possibility that the determination processing based on an abnormal output value continues in a case where a normal output value cannot be obtained from the sensor, such as a case where the steering wheel is exposed to water.

### SUMMARY OF THE INVENTION

An aspect of the present invention is a steering apparatus including: a plurality of sensor units, each including a plurality of sensors, configured to detect contact or proximity of a human body in a plurality of detection target regions provided on a steering wheel; and a microprocessor. The microprocessor is configured to perform: comparing output values of the plurality of sensor units with a determination threshold value, respectively, determining whether or not the steering wheel is being gripped based on a result of the comparing; specifying, based on the output values of the plurality of sensor units, a water-exposed detection target region, which is a detection target region among the plurality of detection target regions that is exposed to water; and when the water-exposed detection target region is specified, changing the determination threshold value from a first value determined before the water-exposed detection target region is specified to a second value different from the first value. The microprocessor is configured to perform the determining including, when a sensor unit corresponding to the water-exposed detection target region is defined as a first sensor unit and a sensor unit corresponding to a region other than the water-exposed detection target region is defined as a second sensor unit, determining whether or not the steering wheel is being gripped by comparing an output value of the second sensor unit with the determination threshold value changed to the second value.

### BRIEF DESCRIPTION OF THE DRAWINGS

The objects, features, and advantages of the present invention will become clearer from the following description of embodiments in relation to the attached drawings, in which:

FIG. 1A is a front view of a steering wheel to which a steering apparatus according to an embodiment of the present invention is applied;

FIG. 1B is a diagram illustrating an example of electrodes embedded in the spoke portion in FIG. 1A;

FIG. 2 is a diagram illustrating a state where a beverage is spilled on the steering wheel in FIG. 1A;

FIG. 3 is a block diagram illustrating a configuration of a main part of the steering apparatus according to the present embodiment;

FIG. 4 is a diagram for describing an expansion of a water-exposed range;

FIG. 5 is a diagram illustrating an example of a configuration of a driving assistance system including the steering apparatus in FIG. 3; and

FIG. 6 is a flowchart illustrating an example of processing to be executed by a CPU of the controller in FIG. 3.

### DETAILED DESCRIPTION OF THE INVENTION

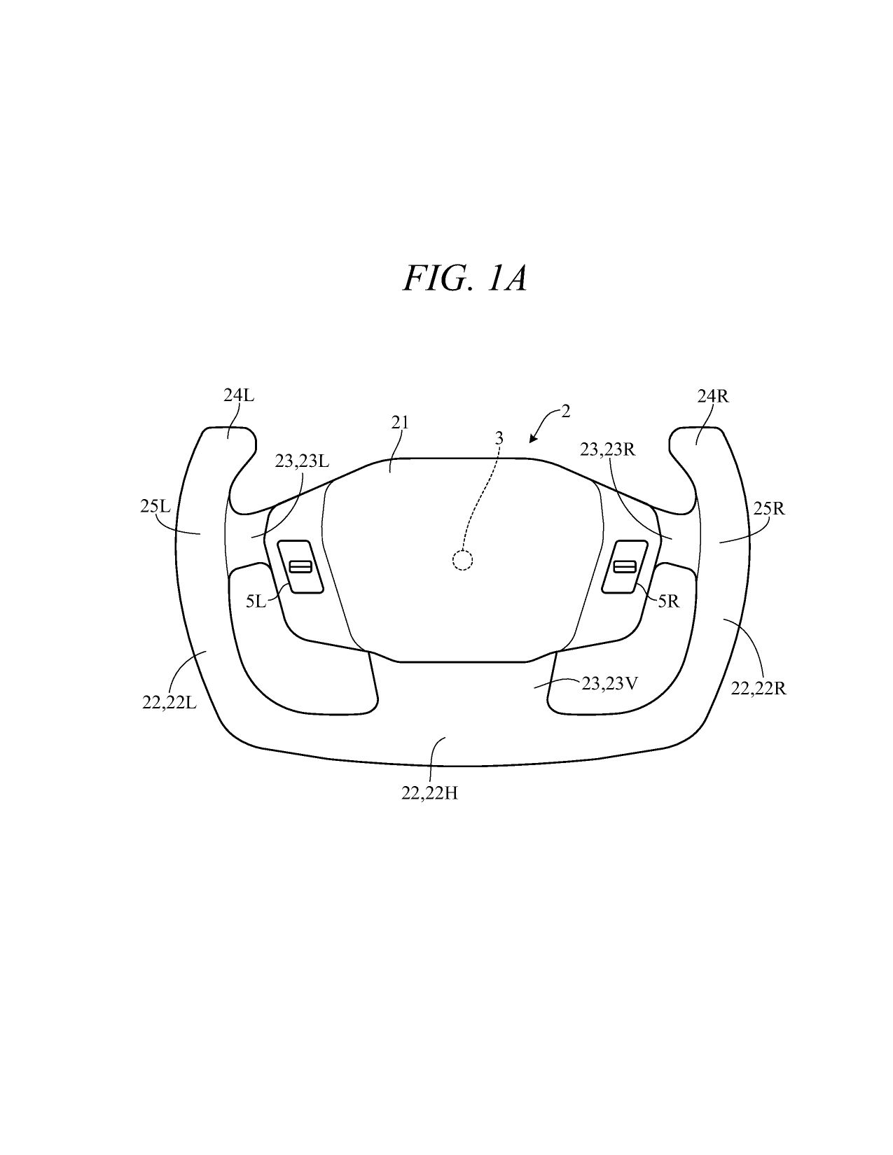

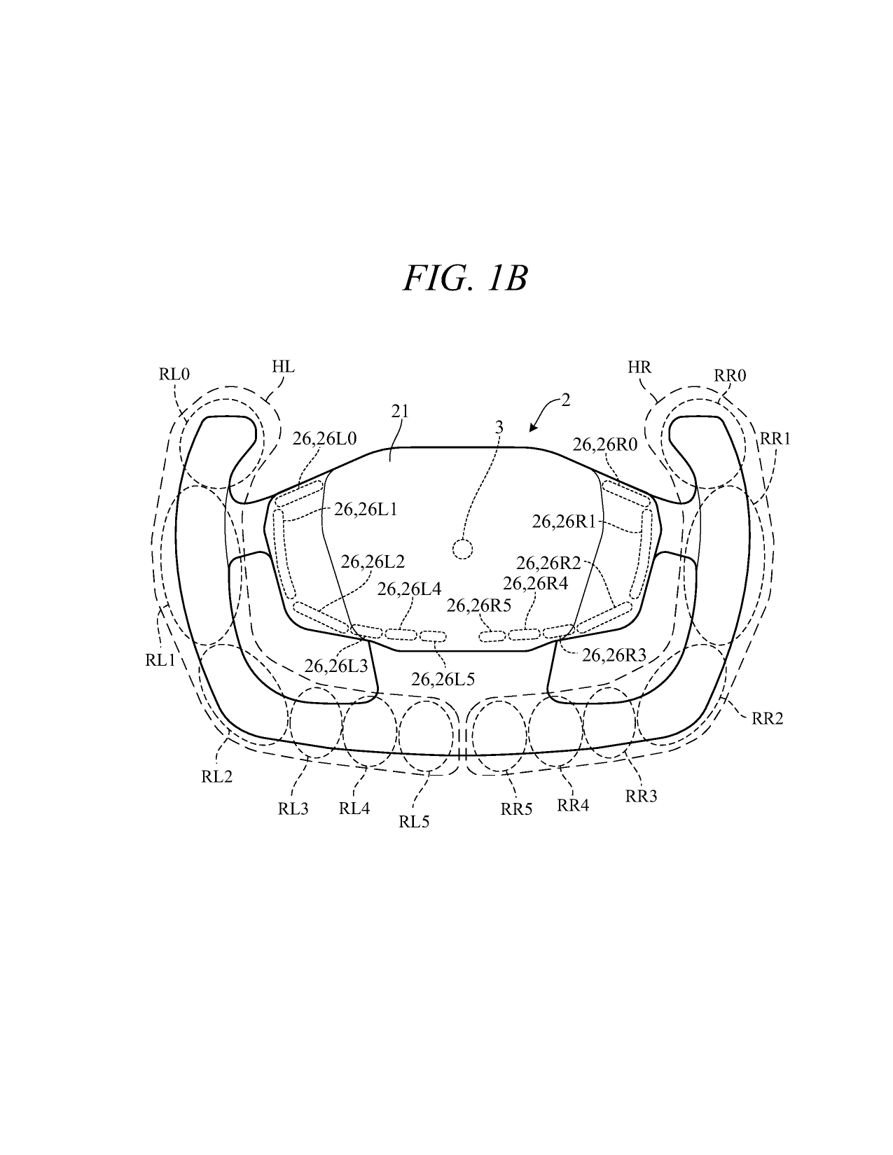

Hereinafter, embodiments of the invention will be described with reference to the drawings. FIG. 1A is a front view of a steering wheel to which a steering apparatus according to an embodiment of the present invention is applied. The steering apparatus according to an embodiment of the present invention is applicable to a manually driven vehicle including a driving assistance system such as advanced driver-assistance systems (ADAS). Note that a vehicle to which the steering apparatus according to the present embodiment is applied will be referred to as a subject vehicle in some cases so as to be distinguished from other vehicles. A steering wheel 2 in FIG. 1A is operated by a driver on a driver's seat of the subject vehicle. A steering shaft 3, which pivotally supports the steering wheel 2, is coupled to the back side of the steering wheel 2 in a front view (as viewed from the driver).

As illustrated in FIG. 1A, the steering wheel 2 is an irregularly shaped steering wheel, and includes a hub portion 21, a rim portion (grip portion) 22, and a spoke portion 23 that connects the hub portion 21 and the rim portion 22. The rim portion 22 includes a pair of left and right rim portions (vertical portions) 22L and 22R that extend substantially in the up-down direction on the left and right sides of the hub portion 21, and a horizontal portion 22H that extends substantially in the left-right direction below the hub portion 21 and connects the rim portions (vertical portions) 22L and 22R to each other. The spoke portion 23 includes horizontal portions 23L and 23R that connect the hub portion 21 to the rim portions (vertical portions) 22L and 22R, and a perpendicular portion 23V that connects the hub portion 21 to the horizontal portion 22H. The rim portion (vertical portion) 22L is provided such that an end portion 24L thereof protrudes upward from a connection portion 25L between the spoke portion (horizontal portion) 23L and the rim portion (vertical portion) 22L. Similarly, the rim portion (vertical portion) 22R is provided such that an end portion 24R thereof protrudes upward from a connection portion 25R between the spoke portion (horizontal portion) 23R and the rim portion (vertical portion) 22R.

As illustrated in FIG. 1A, the spoke portions 23L and 23R are respectively provided with operation console units (hereinafter, referred to as functional switch units) 5L and 5R for allowing the driver to operate vehicle auxiliary devices (not illustrated) (a navigation unit, an audio device, an air conditioning device, and the like), as well as ADAS functions. The driver can operate the vehicle auxiliary devices and the like by operating a plurality of switches provided on the operation console units 5L and 5R with their fingers.

FIG. 1B is a diagram illustrating an example of electrodes embedded in the spoke portion. Note that, for clarity of the drawing, the operation console units 5L and 5R are omitted in FIG. 1B. The hub portion 21 incorporates electrodes 26L0 to 26L5 and 26R0 to 26R5, which are formed in a plate shape and have conductivity. The electrodes 26L0 to 26L5 are provided in the vicinity of a recommended grip region HL for the left hand, which is defined with respect to the rim portion 22 in the steering wheel 2. As illustrated in FIG. 1B, the electrode 26L0 is provided along a side wall surface on the upper left side of the hub portion 21. The electrode 26L1 is provided along a side wall surface on the left side of the hub portion 21. The electrode 26L2 is provided along a side wall surface on the lower left corner of the hub portion 21. The electrodes 26L3 to 26L5 are sequentially provided adjacent to the electrode 26L2, along a side wall surface on the lower left side of the hub portion 21, toward the center of the hub portion 21. Regions RL0 to RL5 represent the detection target regions of the electrodes 26L0 to 26L5. As illustrated in FIG. 1B, the electrodes 26L0 to 26L5 are arranged such that the detection target regions RL0 to RL5 cover the entire recommended grip region HL.

The electrodes 26R0 to 26R5 are provided in the vicinity of a recommended grip region HR for the right hand, which is defined with respect to the rim portion 22 in the steering wheel 2. As illustrated in FIG. 1B, the electrode 26R0 is provided along a side wall surface on the upper right side of the hub portion 21. The electrode 26R1 is provided along a side wall surface on the right side of the hub portion 21. The electrode 26R2 is provided along a side wall surface on the lower right corner of the hub portion 21. The electrodes 26R3 to 26R5 are sequentially provided adjacent to the electrode 26R2, along a side wall surface on the lower right side of the hub portion 21, toward the center of the hub portion 21. Regions RR0 to RR5 represent the detection target regions of the electrodes 26R0 to 26R5. As illustrated in FIG. 1B, the electrodes 26R0 to 26R5 are arranged such that the regions RR0 to RR5 cover the entire recommended grip region HR.

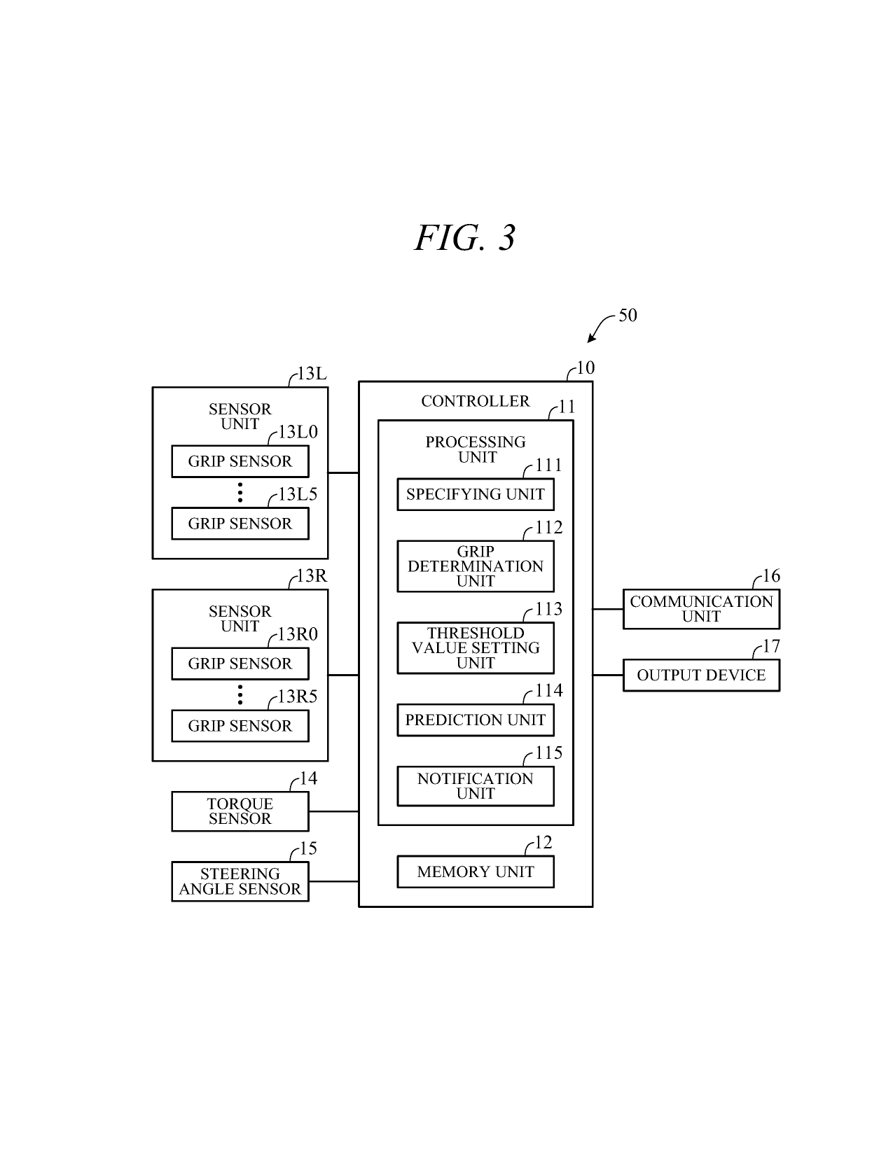

The electrodes 26 (26L0 to 26L5 and 26R0 to 26R5) are respectively connected to grip sensors 13L0 to 13L5 and 13R0 to 13R5 of the sensor units 13L and 13R in FIG. 3, which will be described later, via signal lines (not illustrated).

FIG. 3 is a block diagram illustrating a configuration of a main part of the steering apparatus according to the present embodiment. As illustrated in FIG. 3, a steering apparatus 50 includes a controller 10, the sensor units 13L and 13R, a steering torque sensor (hereinafter, simply referred to as a torque sensor) 14, a steering angle sensor 15, a communication unit 16, and an output device 17. The communication unit 16 connects the steering apparatus 50 to a communication network (network) such as a controller area network (CAN). The steering apparatus 50 is capable of performing communication with an in-vehicle device (not illustrated) via the communication unit 16 through CAN communication or the like. Note that the steering apparatus 50 may be capable of performing communication with an in-vehicle device or an external device (not illustrated) via a wireless communication network.

The sensor unit 13L includes the grip sensors 13L0 to 13L5 respectively connected to the electrodes 26L0 to 26L5 in FIG. 1B via signal lines (not illustrated). The sensor unit 13R includes the grip sensors 13R0 to 13R5 respectively connected to the electrodes 26R0 to 26R5 in FIG. 1B via signal lines (not illustrated). The grip sensors 13L0 to 13L5 and 13R0 to 13R5 detect electrical characteristics (for example, capacitance between the electrode and ground (for example, vehicle body)) of the electrodes 26L0 to 26L5 and 26R0 to 26R5, respectively.

The torque sensor 14 detects torque, that is, the steering torque around the rotation axis of the steering wheel 2 input by the driver.

The steering angle sensor 15 detects a steering angle in accordance with a steering operation of the driver. The steering angle is represented by a clockwise angle that is centered on the steering shaft 3 with reference to the center position in the left-right direction of an upper end portion of the hub portion 21 as viewed from the driver. In addition, the neutral position (0 [deg]) of the steering wheel 2 is a position where the steering wheel 2 is not operated in either the clockwise direction or the counterclockwise direction and the steered wheels (front wheels, rear wheels, or front and rear wheels) of the subject vehicle are not steered either to the left or to the right.

The output device 17 is a generic term for devices that output information to the driver. The output device 17 includes a display that provides the driver with information via a display image, a speaker that provides the driver with information by sound, and the like.

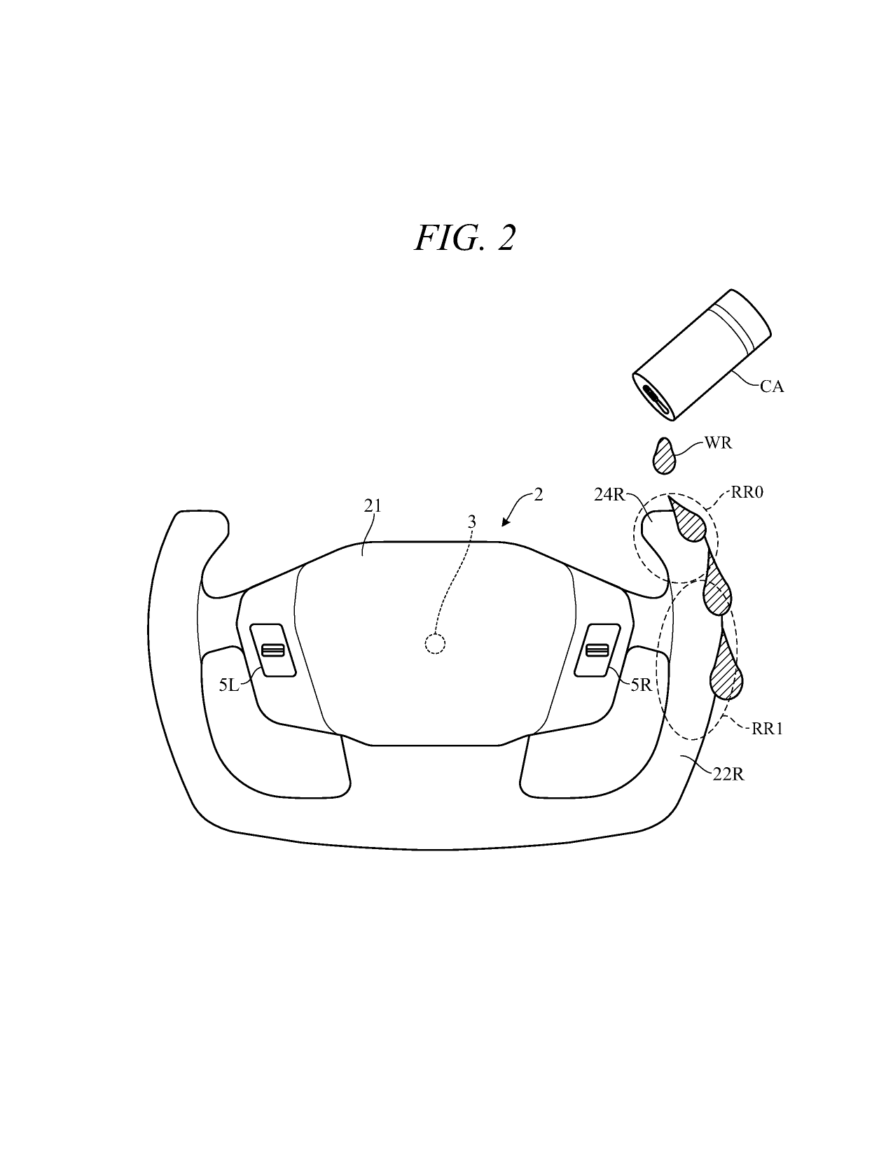

Incidentally, the capacitive sensors such as the grip sensors 13L0 to 13L5 and 13R0 to 13R5 have a characteristic in which the detection sensitivity is increased due to water or moisture. FIG. 2 is a diagram illustrating a state where a beverage is spilled on the steering wheel 2. FIG. 2 illustrates a state where a beverage WR spilled from a container (can) CA drips downward from the rim portion 22R along the rim portion 22R from the end portion 24R. Hereinafter, as illustrated in FIG. 2, wetting of the steering wheel 2 due to application of a liquid such as water is expressed as the steering wheel 2 being exposed to water.

As illustrated in FIG. 2, in a case where the surface of the steering wheel 2 is exposed to a beverage or in a case where the driver grips the steering wheel 2 with wet hands, resulting in water exposure of the steering wheel 2, the electrodes corresponding to the water-exposed region exhibit increased detection sensitivity due to the above-described characteristics. In the example in FIG. 2, the detection sensitivity of the electrodes 26R0 and 26R1, which correspond to the water-exposed regions RR0 and RR1, is increased. Therefore, in a case where the steering wheel 2 is exposed to water when determining the grip of steering wheel 2 on the basis of the magnitude of the capacitance detected by the electrodes, there is a risk of erroneously determining that the steering wheel 2 is being gripped even though the steering wheel 2 is not actually being gripped. Therefore, in order to handle such an issue, the controller 10 of the steering apparatus 50 is configured as follows in the present embodiment.

The controller 10 includes a processing unit 11 such as a CPU (microprocessor) and a memory unit 12. The processing unit 11 includes, as functional configurations, a water-exposed region specifying unit (hereinafter, simply referred to as a specifying unit) 111, a grip determination unit 112, a threshold value setting unit 113, a prediction unit 114, and a notification unit 115. The memory unit 12 stores programs for various kinds of control and information such as threshold values used in the programs.

The specifying unit 111 specifies a recommended grip region (hereinafter, referred to as a water-exposed region) that has been exposed to water, among the recommended grip regions HL and HR on the basis of the output values of the grip sensors of the sensor units 13L and 13R. Specifically, when the output value of any grip sensor included in the output values of the sensor units is equal to or greater than a predetermined value PC, the specifying unit 111 specifies the corresponding recommended grip region as the water-exposed region. Note that the output value of the sensor unit 13L is a value obtained by integrating the output values (detection values) of the grip sensors 13L0 to 13L5. In addition, the output value of the sensor unit 13R is a value obtained by integrating the output values (detection values) of the grip sensors 13R0 to 13R5. The predetermined value PC may be set to a value indicating a detection error of the grip sensor, or may be set to a value measured in advance through experiments or the like.

The grip determination unit 112 detects the presence or absence of contact of a human body with the recommended grip regions HL and HR on the basis of whether the output values of the sensor units 13L and 13R are equal to or greater than a determination threshold value C_Th. When the contact of a human body with any of the recommended grip regions HL and HR is detected, the grip determination unit 112 determines that the steering wheel 2 is being gripped by the driver.

Note that, in a case where the approach of a human body to the recommended grip regions HL and HR (an approaching motion within a predetermined distance) is detected, it can be determined that the driver can immediately grip the steering wheel 2. Therefore, even in a case where the approach of a human body to any of the recommended grip regions HL and HR is detected, the grip determination unit 112 may determine that the steering wheel 2 is being gripped by the driver. That is, when the contact or approach of a human body with respect to any of the recommended grip regions HL and HR is detected, the grip determination unit 112 may determine that the steering wheel 2 is being gripped by the driver. Note that in a case where the contact or approach with respect to the recommended grip regions HL and HR is detected, the determination threshold value C_Th is set to a smaller value than in a case where only the contact with the recommended grip regions HL and HR is detected.

When the water-exposed region is specified by the specifying unit 111, the threshold value setting unit 113 changes the determination threshold value C_Th that used for the determination by the grip determination unit 112, from a value Th1, which is defined before the water-exposed region is specified by the specifying unit 111, to a value Th2 different from the value Th1. The value Th2 is smaller than the value Th1 and is, for example, a value of 1/2 of the value Th1.

When the determination threshold value C_Th is changed from the value Th1 to the value Th2 by the threshold value setting unit 113, the grip determination unit 112 performs the grip determination of the steering wheel 2 using the output value of the sensor unit (the sensor unit 13L in the example in FIG. 2) corresponding to the recommended grip region that has not been exposed to water (hereinafter, referred to as a non-water-exposed region). More specifically, the grip determination unit 112 compares the output value of the sensor unit corresponding to the non-water-exposed region with the determination threshold value C_Th (value Th2), and determines that the steering wheel 2 is being gripped when the output value is equal to or greater than the determination threshold value C_Th (value Th2).

In a case where a water-exposed region is specified by the specifying unit 111, the prediction unit 114 predicts that, when the output value of a sensor unit positioned in the vicinity of the sensor unit corresponding to the water-exposed region is gradually increased, the detection target region (recommended grip region) of the sensor unit may be exposed to water in the future. In the example in FIG. 2, immediately after the beverage WR is spilled from the container CA, only the region RR0 is exposed to water, but as the beverage WR drips downward along the rim portion 22R, the region RR1 becomes exposed to water. As described above, the water-exposed range in the recommended grip region HR gradually expands over time and, in some cases, may even extend to the recommended grip region HL, which is not exposed to water.

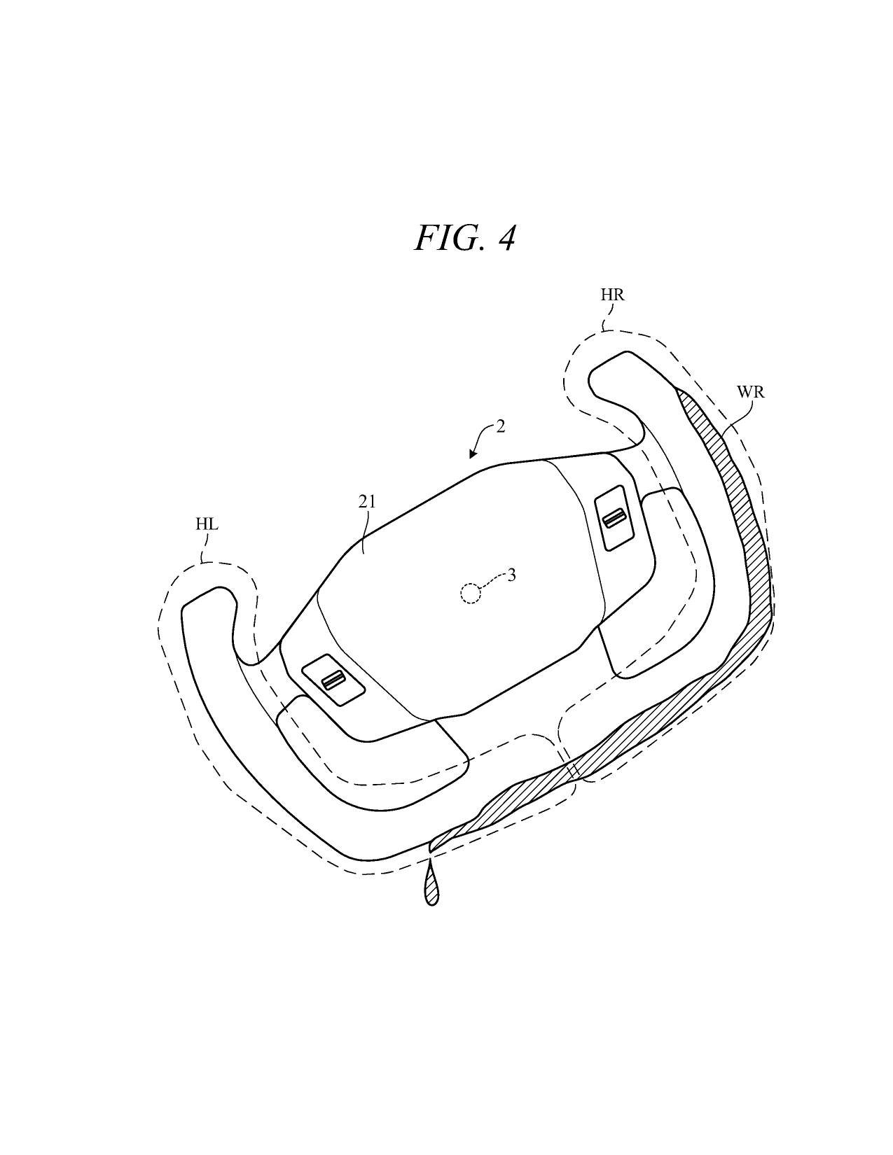

FIG. 4 is a diagram for describing the expansion of the water-exposed range. As illustrated in FIG. 4, when the steering wheel 2 is turned counterclockwise in a state where the beverage WR has been spilled (in FIG. 2), the beverage WR reaches the recommended grip region HL, which is in a non-water-exposed range. Thereafter, as the water-exposed range in the recommended grip region HL expands over time, the output value of the sensor unit 13L corresponding to the recommended grip region HL is gradually increased. In a case where the recommended grip region HR is specified as the water-exposed region by the specifying unit 111, the prediction unit 114 monitors (periodically acquires) the output value of another sensor unit (sensor unit 13L in the example in FIG. 4) positioned in the vicinity of the sensor unit 13R corresponding to the water-exposed region (recommended grip region HR). When the gradual increase of the output value of the sensor unit 13L is recognized as a result of the monitoring, the prediction unit 114 predicts that the detection target region (recommended grip region) HL of the sensor unit 13L may be exposed to water in the future.

In a case where both the recommended grip regions HL and HR are exposed to water, the grip determination unit 112 can no longer perform accurate grip determination. Therefore, in a case where both the recommended grip regions HL and HR are exposed to water, the grip determination unit 112 performs the grip determination of the steering wheel 2 by using the detection value of the torque sensor 14 instead of the output values of the sensor units 13L and 13R. Specifically, after the prediction unit 114 predicts that the recommended grip region HL may be exposed to water in the future, in a case where any output value of the grip sensors 13L0 to 13L5 of the sensor unit 13L becomes equal to or greater than the predetermined value PC, the grip determination unit 112 determines that both the recommended grip regions HL and HR are exposed to water. When it is determined that both the recommended grip regions HL and HR are exposed to water, the grip determination unit 112 starts the grip determination of the steering wheel 2 using the detection value of the torque sensor 14. The grip determination unit 112 determines whether or not the steering wheel 2 is being gripped on the basis of whether the detection value of the torque sensor 14 is equal to or greater than a determination threshold value T_Th. As the determination threshold value T_Th, a value smaller than the detection value (hereinafter, referred to as a reference detection value) of the torque sensor when the output values of the sensor units 13L and 13R are the value Th1 is set. The reference detection value is pre-measured through experiments or the like.

The notification unit 115 generates information (hereinafter, referred to as grip state information) indicating a grip state on the basis of the determination result of the grip determination unit 112. In a case where the grip determination unit 112 determines that the steering wheel 2 is being gripped, the notification unit 115 generates grip state information indicating “grip (normal)” as the grip state. In addition, in a case where the grip determination unit 112 determines that the steering wheel 2 is not being gripped, the notification unit 115 generates grip state information indicating “non-grip” as the grip state. The notification unit 115 outputs the generated grip state information to the output device 17 mounted in the subject vehicle.

Note that when generating the grip state information indicating “non-grip”, the notification unit 115 may include warning information for prompting the driver to grip the steering wheel 2, in the grip state information. The warning information may include display information or audio information output via a display or speaker, as well as a signal for turning on or blinking a warning light or the like provided on the steering wheel 2 or in the vicinity (instrument panel or the like) of the steering wheel 2. In addition, the notification unit 115 may output the grip state information to the in-vehicle device or the external device via the communication unit 16.

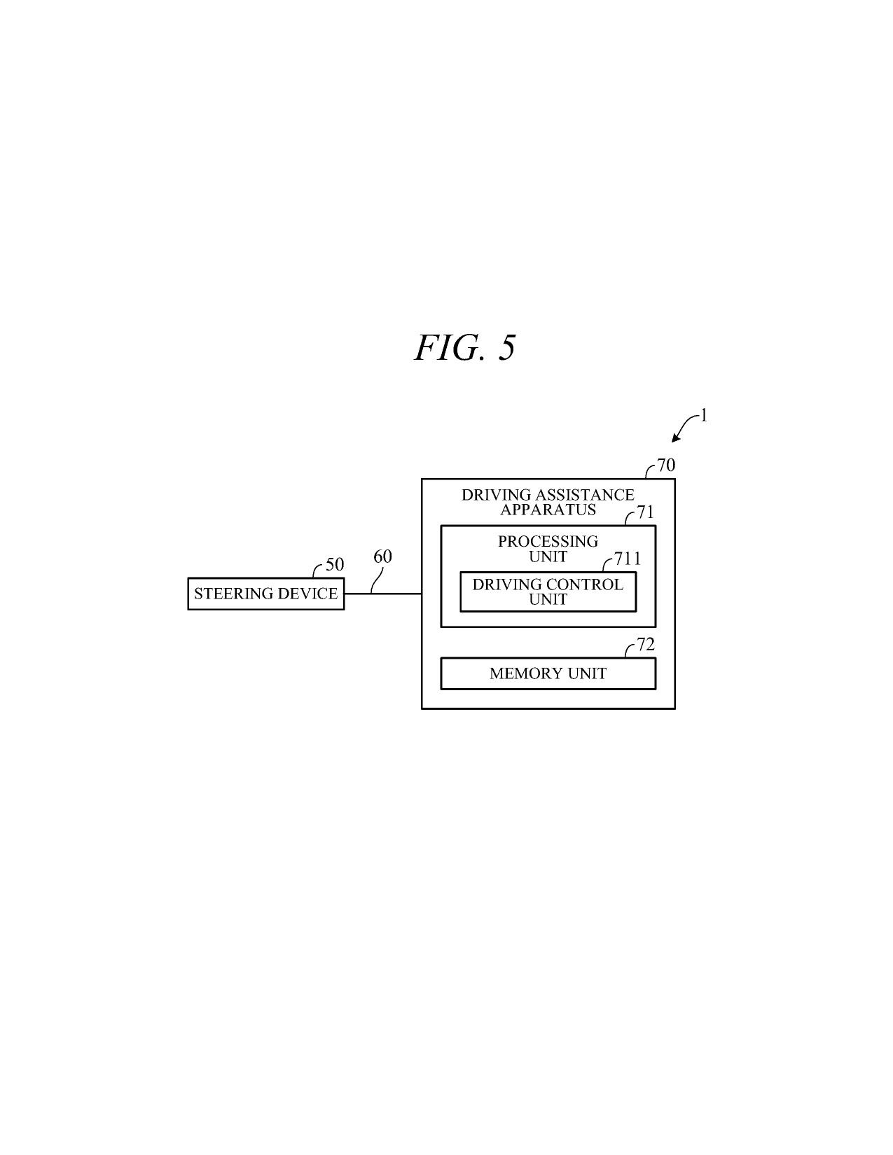

FIG. 5 is a diagram illustrating an example of a configuration of a driving assistance system 1 including the steering apparatus 50 according to the present embodiment. As illustrated in FIG. 5, the driving assistance system 1 includes the steering apparatus 50 and a driving assistance apparatus 70 that is one of in-vehicle devices. The steering apparatus 50 is communicably connected to the driving assistance apparatus 70 through a CAN bus 60.

The driving assistance apparatus 70 includes an electronic control unit (ECU). The driving assistance apparatus 70 includes a processing unit 71 such as a CPU (microprocessor) and a memory unit 72. The processing unit 71 includes a driving control unit 711 as a functional configuration. The memory unit 72 stores programs for various kinds of control and information such as threshold values used in the programs. The driving control unit 711 controls an actuator for driving (not illustrated) on the basis of information (camera image or the like) obtained from an in-vehicle sensor. The actuator for driving includes a throttle actuator that adjusts the opening degree (throttle opening degree) of a throttle valve of an engine, a brake actuator that actuates a braking device of the subject vehicle, a steering actuator that drives a steering apparatus, and the like.

The driving assistance apparatus 70 has various driving assistance functions such as LKAS and adaptive cruise control (ACC). When the LKAS is effective, the driving control unit 711 recognizes a division line that defines the current lane on the basis of the information obtained from the in-vehicle sensor, and controls the steering actuator such that the subject vehicle travels near the center of the current lane.

In this case, the driving control unit 711 acquires the grip state information output from the notification unit 115 of the steering apparatus 50 through the CAN bus 60, and recognizes the grip state of the steering wheel 2 on the basis of the grip state information. When the driver's non-grip on the steering wheel 2 is recognized, the driving control unit 711 temporarily stops the driving assistance (steering assistance) by the LKAS. When the state of the driver's non-grip continues for a predetermined time, the driving control unit 711 cancels the steering assistance. When the driver's grip on the steering wheel 2 is recognized before the state of the driver's non-grip continues for a predetermined time, the temporarily stopped steering assistance is restarted. In this manner, the grip state information output from the steering apparatus 50 is used for controlling temporary stop, restart, cancellation, or the like of the driving assistance function in the driving assistance apparatus 70.

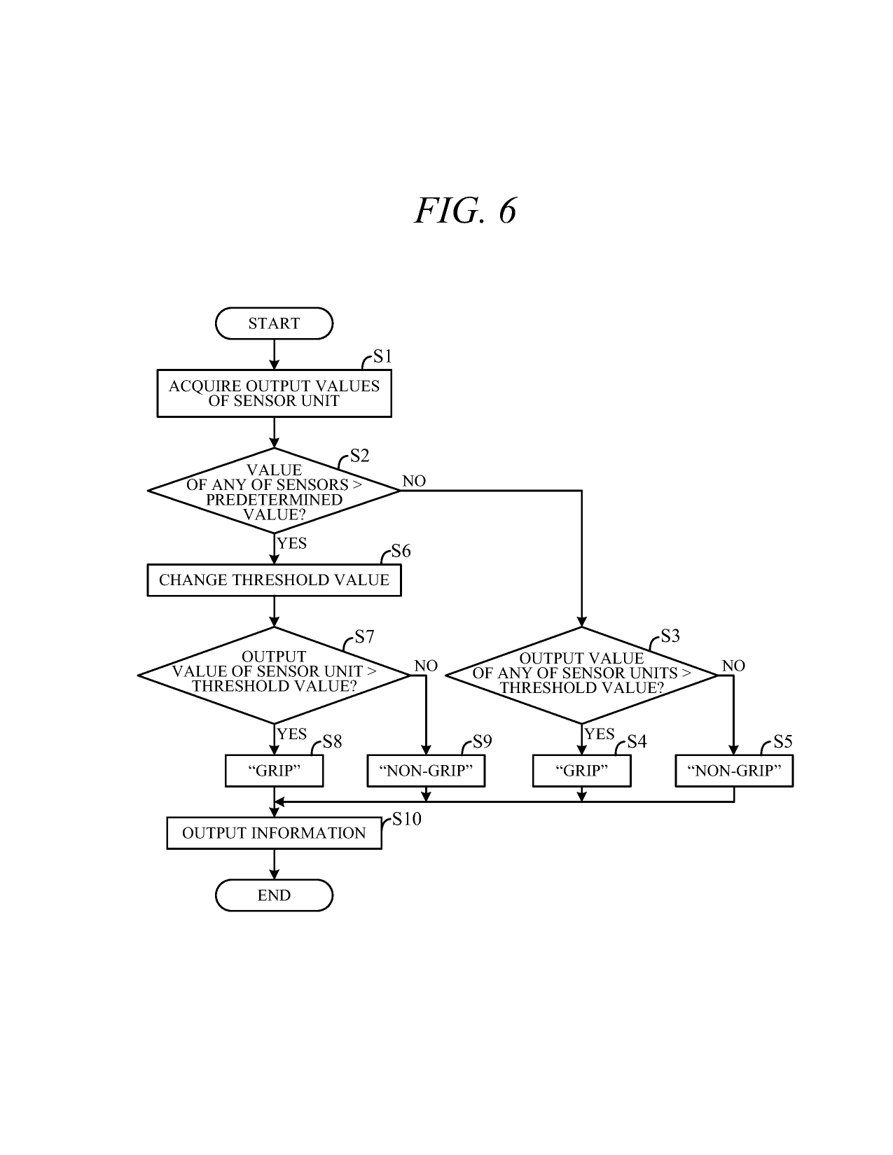

FIG. 6 is a flowchart illustrating an example of processing to be executed by the CPU of the controller 10 in FIG. 3 in accordance with a predetermined program. The processing illustrated in the flowchart is executed at a predetermined cycle while the subject vehicle is traveling, for example.

First, in step S1, the controller 10 acquires the output values of the sensor units 13L and 13R. Specifically, the controller 10 integrates the output values of the grip sensors 13L0 to 13L5, and acquires a calculation result thereof as the output value of the sensor unit 13L. In addition, the controller 10 integrates the output values of the grip sensors 13R0 to 13R5, and acquires a calculation result thereof as the output value of the sensor unit 13R. In step S2, it is determined whether or not any of the sensor units 13L and 13R includes a grip sensor of which the output value is equal to or greater than the predetermined value PC.

When the determination in step S2 is negative, the controller 10 determines that none of the recommended grip regions HL and HR corresponding to the sensor units 13L and 13R is exposed to water, and the processing proceeds to the processing in step S3. In step S3, the controller 10 determines whether any output value of the sensor units 13L and 13R is equal to or greater than the determination threshold value C_Th. Note that the value Th1 is set as an initial value of the determination threshold value C_Th. In addition, when the value Th2 is set to the determination threshold value C_Th, the controller 10 changes the determination threshold value C_Th from the value Th2 to the value Th1, and then performs the determination processing in step S3.

When the determination in step S3 is affirmative, the controller 10 determines in step S4 that the steering wheel 2 is being gripped by the driver, and generates grip state information indicating “grip (normal)”. On the other hand, when the determination in step S3 is negative, the controller 10 determines in step S5 that the steering wheel 2 is not being gripped by the driver, and generates grip state information indicating “non-grip”.

On the other hand, when the determination in step S2 is affirmative, the controller 10 specifies the recommended grip region corresponding to the sensor unit including the grip sensor of which the output value is equal to or greater than the predetermined value PC, as the water-exposed region, and the processing proceeds to step S6. In step S6, the controller 10 changes the determination threshold value C_Th from the value Th1 to the value Th2. In step S7, the controller 10 determines whether the output value of the sensor unit corresponding to the non-water-exposed region is equal to or greater than the determination threshold value C_Th (value Th2).

When the determination in step S7 is affirmative, the controller 10 determines in step S8 that the steering wheel 2 is being gripped by the driver, and generates grip state information indicating “grip (normal)”. On the other hand, when the determination in step S7 is negative, the controller 10 determines in step S9 that the steering wheel 2 is not being gripped by the driver, and generates grip state information indicating “non-grip”.

Finally, in step S10, the controller 10 outputs the grip state information generated in step S4, S5, S8, or S9 to the output device 17, and ends the processing.

According to the above-described embodiment, the following effects can be achieved.

(1) The steering apparatus 50 includes the sensor units 13L and 13R including the grip sensors 13L0 to 13L5 and 13R0 to 13R5 which detect the contact or approach of a human body with respect to the detection target regions (recommended grip regions HL and HR in FIG. 1B) provided in the steering wheel 2; the grip determination unit 112 that determines whether or not the steering wheel 2 is being gripped by comparing the output value of each of the sensor units 13L and 13R with the determination threshold value C_Th; the specifying unit 111 that specifies the water-exposed region (hereinafter, referred to as a water-exposed detection target region) as the detection target region that is exposed to water among the detection target regions HL and HR on the basis of the output values of the sensor units 13L and 13R; and the threshold value setting unit 113 that, when the water-exposed region is specified by the specifying unit 111, changes the determination threshold value C_Th from the value Th1, which is determined before the water-exposed region is specified by the specifying unit 111, to the value Th2 (< value Th1) different from the value Th1. When, among the sensor units 13L and 13R, the sensor unit corresponding to the water-exposed region specified by the water-exposed region specifying unit is defined as a first sensor unit, and the sensor unit corresponding to a region other than the water-exposed region is defined as a second sensor unit, the grip determination unit 112 determines whether or not the steering wheel 2 is being gripped by comparing the output value of the second sensor unit with the determination threshold value C_Th that has been changed to the value Th2. The grip determination unit 112 determines that the steering wheel 2 is being gripped when the output value of the second sensor unit is equal to or greater than the determination threshold value C_Th (value Th2). The detection target regions HL and HR are provided at different positions on the steering wheel 2. The grip sensors 13L0 to 13L5 detect the contact or approach of a human body with respect to the respective regions RL0 to RL5 that are obtained by dividing the detection target region HL. The grip sensors 13R0 to 13R5 detect the contact or approach of a human body with respect to the respective regions RR0 to RR5 that are obtained by dividing the detection target region HR. The output value of the sensor unit 13L is the integrated value of the output values of the grip sensors 13L0 to 13L5, and the output value of the sensor unit 13R is the integrated value of the output values of the grip sensors 13R0 to 13R5.

Meanwhile, since the second sensor unit corresponding to the recommended grip region that is not exposed to water (non-water-exposed region) is located at a distance from the recommended grip region that is exposed to water (water-exposed region), the response of the sensor electrodes of the second sensor unit to the water-exposed region becomes smaller depending on the distance. Therefore, in the second sensor unit, it is difficult to accurately detect the contact or approach of a human body with respect to the water-exposed region. However, as described above, by lowering the threshold value for the grip determination in a case where the water exposure of the steering wheel 2 is detected, it becomes possible to accurately detect not only the contact or approach of a human body with respect to the non-water-exposed region but also the contact or approach of a human body with respect to the water-exposed region by using the output value of the second sensor unit. As a result, even in a case where the recommended grip region is exposed to water and normal output values can no longer be obtained from the corresponding sensor unit, erroneous determination of the grip/non-grip state due to water exposure can be suppressed.

(2) The steering apparatus 50 further includes the output device 17 that outputs information, and the notification unit 115 that notifies the driver, via the output device 17, of information generated on the basis of the determination result by the grip determination unit 112. This enables the driver to recognize the result of the grip determination. In addition, the result of the grip determination can be used for the driving assistance function such as the LKAS. As a result, the safety while operating the steering wheel can be improved.

(3) The specifying unit 111 specifies, as the water-exposed region, the detection target region corresponding to the sensor unit including the grip sensor of which the output value is equal to or greater than the predetermined value PC, among the sensor units 13L and 13R. The threshold value setting unit 113 changes the determination threshold value C_Th from the value Th2 to the value Th1 when the output values of all the sensors included in the first sensor unit become less than the predetermined value. As a result, in a case where the water-exposed state is resolved by the driver wiping the surface of the steering wheel 2 or by natural evaporation of moisture, the threshold value for the grip determination is returned to the initial value (default value), and the grip determination based on the output values of both the sensor units 13L and 13R is resumed. As a result, the grip determination after the water-exposed state is resolved can be continued with the same level of accuracy as before the water exposure.

(4) The steering wheel 2 includes the hub portion 21; the rim portion (grip portion) 22 having the pair of left and right vertical portions 22L and 22R that extend in a substantially up-down direction on the left and right sides of the hub portion 21, and the horizontal portion 22H that extends substantially in the left-right direction below the hub portion 21 and connects the pair of left and right vertical portions 22L and 22R to each other; and the spoke portions 23L and 23R that connect the pair of left and right vertical portions 22L and 22R to the hub portion 21. The sensor units 13L and 13R (more specifically, the electrodes of the grip sensors included in the sensor units 13L and 13R) are arranged in the vicinity of functional switch units 5L and 5R, which are respectively disposed on the left and right portions of the hub portion 21 and are used for the vehicle information operation or the driving assistance function operation. In this manner, by providing the sensor unit on each of the functional switch units symmetrically arranged on the hub portion 21, it is possible to appropriately detect the contact or approach of a human body with respect to the recommended grip regions symmetrically arranged on the rim portion 22.

(5) The steering apparatus 50 further includes the prediction unit 114 that, in a case where the water-exposed region is specified by the specifying unit 111, predicts that the detection target region (non-water-exposed region) of the second sensor unit may be exposed to water in the future when the output value of the second sensor unit located in the vicinity of the first sensor unit is gradually increased; and the torque sensor 14 that detects steering torque acting on the shaft of the steering wheel 2. The grip determination unit 112 determines whether or not the steering wheel 2 is being gripped on the basis of the detection value of the torque sensor 14 in a case where, after the prediction unit 114 predicts that the detection target region (non-water-exposed region) of the second sensor unit may be exposed to water in the future, the output value of any grip sensor of the second sensor unit becomes equal to or greater than the predetermined value PC.

In a case where the water-exposed portion is an upper portion of the steering wheel 2, the water-exposed range may spread from the upper portion to the lower portion depending on the extent of the water exposure. In addition, the water-exposed range may also expand similarly in a case where the steering wheel 2 is turned by the driver’s steering operation or by the automatic steering function. As the water-exposed range of the steering wheel 2 becomes more widespread in this manner, the reliability of the grip determination (by the capacitive sensor) is decreased. However, when the water-exposed range expands to the non-water-exposed region, that is, when a normal output value can no longer be obtained from any of the sensor units, the grip/non-grip state can be accurately determined by substituting the detection value of the torque sensor 14 as described above, even in a case where the entire steering wheel 2 is exposed to water.

(6) Each of the sensor units 13L and 13R includes the capacitive sensor. The output values of the sensor units 13L and 13R include information on the capacitance detected by the capacitive sensors. The grip determination unit 112 determines that the steering wheel 2 is being gripped when the detection value of the torque sensor 14 is equal to or greater than the determination threshold value T_Th. As the determination threshold value T_Th, a value smaller than the reference detection value (that is, the detection value of the torque sensor 14 when the output values of the sensor units 13L and 13R are the value Th1) is set. Unlike the capacitive sensor correlated with the electrical characteristics of a human body, the torque sensor determines the contact based on the load applied to the steering wheel 2 by a human body, and thus, the grip determination can be accurately performed by lowering the threshold value compared to the determination threshold value by the capacitive sensor. Note that in a case where the torque sensor is used, the upper and lower portions of the steering wheel 2 tend to receive more load, and the torque detection values tend to become larger compared to other positions. Therefore, the grip determination unit may recognize the grip position on the steering wheel 2 on the basis of the output values of the grip sensors 13L0 to 13L5 and 13R0 to 13R5, and may appropriately change the determination threshold value T_Th in accordance with the grip position. For example, when the recognized grip position is included in the detection target regions RL1 and RR1, the grip determination unit may reduce the determination threshold value T_Th to be smaller than that when the recognized grip position is not included in the detection target regions RL1 and RR1. Note that the grip position on the steering wheel 2 may also be recognized on the basis of other information.

The above embodiments may be modified into various modes. Hereinafter, modified examples will be described. In the embodiment described above, the notification unit 115 is configured to generate the grip state information indicating the determination result of the grip determination unit 112. However, the notification unit may generate information (hereinafter, referred to as water-exposed state information) regarding the water-exposed region specified by the specifying unit 111, in the grip state information. The notification unit may output the water-exposed state information together with the grip state information to the output device 17. The water-exposed state information may include information (display information, audio information, or the like) that can specify the water-exposed location. In addition, the water-exposed state information may include instruction information (display information, audio information, or the like) that instructs an occupant to wipe off the water-exposed location. In addition, in the embodiment described above, when it is recognized that the driver is not gripping the steering wheel 2, the driving control unit 711 temporarily stops the driving assistance (steering assistance or the like), and when the non-grip state continues for a predetermined time, the driving control unit 711 cancels the driving assistance. However, the driving control unit may also temporarily stop or cancel the driving assistance on the basis of the water-exposed state information output (transmitted) from the notification unit. For example, the driving control unit may temporarily stop or cancel the driving assistance according to the position of the water-exposed location, the size of the water-exposed range, or the duration of the water-exposed state. As a specific example, when the water-exposed location is the detection target regions RR1 and RR2, and RL1 and RL2 which are respectively positioned at the center of the recommended grip region HR and HL, among the detection target regions RR0 to RR5 and RL0 to RL5, the driving assistance may be temporarily stopped or canceled. In addition, when the water-exposed range in the recommended grip regions HR and HL accounts for a proportion equal to or greater than a predetermined value of those regions, the driving assistance may be temporarily stopped or canceled. Furthermore, when the water-exposed state in the recommended grip regions HR and HL continues for a predetermined time or longer, the driving assistance may be temporarily stopped or canceled.

In addition, in the embodiment described above, in a case where the water-exposed region is specified by the specifying unit 111, the prediction unit 114 predicts that, when the output value of the second sensor unit positioned in the vicinity of the first sensor unit is gradually increased, the detection target region (non-water-exposed region) of the second sensor unit may be exposed to water in the future. However, the prediction unit may predict the possibility that the non-water-exposed region is exposed to water in the future, on the basis of the sensor value of the steering angle sensor 15, together with the output value of the second sensor unit or in place of the output value of the second sensor unit. For example, as in the example of FIG. 2, in a case where the recommended grip region HR on the right side is specified as the water-exposed region, when the steering angle of the steering wheel 2 is changed counterclockwise by an angle equal to or greater than a predetermined angle from the time point of specification, the prediction unit may predict that the recommended grip region HL may be exposed to water in the future. In addition, when the steering angle detected by the steering angle sensor 15 is changed by an angle equal to or greater than the predetermined angle from the time point when the first sensor unit is specified as the water-exposed detection target region by the specifying unit 111, in a case where the second sensor unit is positioned on a side opposite to the first sensor unit in a steering direction of the steering wheel, the prediction may be made that the detection target region of the second sensor unit may be exposed to water in the future.

In addition, in the embodiment described above, the sensor units 13L and 13R detect the contact or approach of a human body with respect to the rim portion 22. However, the sensor unit may further detect a gripping force on the rim portion 22. In this case, a pressure sensor is embedded in the rim portion 22, and the sensor unit detects the gripping force on the steering wheel 2 on the basis of sensor values obtained from the pressure sensor via a signal line (not illustrated). The determination unit may determine whether or not the steering wheel 2 is being gripped on the basis of the magnitude of the gripping force detected by the pressure sensor, either together with the output values from the sensor units 13L and 13R, or in place of the output values from the sensor units 13L and 13R. Note that any sensor other than the pressure sensor may be used for detecting the gripping force on the steering wheel 2.

In addition, in the embodiment described above, the case where the controller 10 executes the processing in FIG. 6 while the subject vehicle is traveling has been given as an example. However, the controller 10 may start the processing in FIG. 6 when a notification indicating that the driving assistance function such as the LKAS is effective is received from the driving assistance apparatus 70. In addition, while the traveling speed of the subject vehicle is equal to or lower than a predetermined speed, the controller 10 may not execute the processing in FIG. 6. Furthermore, when a driving assistance function that does not require the driver to grip the steering wheel 2, such as an automatic parking function (parking assist system), is effective, the processing in FIG. 6 may not be executed.

In addition, in the embodiment described above, the irregularly shaped steering wheel is illustrated as the steering wheel 2, but the present invention is also applicable in a case where a steering wheel of another shape (circular or the like) is used. Furthermore, in the embodiment described above, the steering apparatus 50 is applied to the manually driven vehicle including the ADAS, but the steering apparatus 50 is also applicable to a self-driving vehicle.

The above embodiment can be combined as desired with one or more of the above modifications. The modifications can also be combined with one another.

According to the present invention, it is possible to accurately determine the grip state and the non-grip state of the steering wheel.

Above, while the present invention has been described with reference to the preferred embodiments thereof, it will be understood, by those skilled in the art, that various changes and modifications may be made thereto without departing from the scope of the appended claims.

What is claimed is:

1. A steering apparatus comprising:
a plurality of sensor units, each including a plurality of sensors, configured to detect contact or proximity of a human body in a plurality of detection target regions provided on a steering wheel; and
a microprocessor, wherein
the microprocessor is configured to perform:
comparing output values of the plurality of sensor units with a determination threshold value, respectively,
determining whether or not the steering wheel is being gripped based on a result of the comparing;
specifying, based on the output values of the plurality of sensor units, a water-exposed detection target region, which is a detection target region among the plurality of detection target regions that is exposed to water; and
when the water-exposed detection target region is specified, changing the determination threshold value from a first value determined before the water-exposed detection target region is specified to a second value different from the first value, wherein,
the microprocessor is configured to perform
the determining including, when a sensor unit corresponding to the water-exposed detection target region is defined as a first sensor unit and a sensor unit corresponding to a region other than the water-exposed detection target region is defined as a second sensor unit, determining whether or not the steering wheel is being gripped by comparing an output value of the second sensor unit with the determination threshold value changed to the second value.

2. The steering apparatus according to claim 1, wherein
the microprocessor is configured to perform
the determining including determining that the steering wheel is being gripped when any of the output values of the plurality of sensor units is equal to or greater than the determination threshold value; and
the changing including, when the water-exposed detection target region is specified, changing the determination threshold value from the first value to the second value smaller than the first value.

3. The steering apparatus according to claim 1, wherein
the plurality of detection target regions are respectively provided at different positions on the steering wheel,
each of the plurality of sensors detects contact or proximity of a human body in a respective region obtained by dividing a detection target region assigned to the respective sensor among the plurality of detection target regions, and
each of the output values of the plurality of sensor units is, respectively, an integrated value of the output values of the plurality of sensors.

4. The steering apparatus according to claim 1, further comprising
an output device for outputting information, wherein
the microprocessor is further configured to perform notifying a driver, via the output device, of information generated based on a result of the determining.

5. The steering apparatus according to claim 2, wherein
the microprocessor is configured to perform:
the specifying including specifying as the water-exposed detection target region, a detection target region corresponding to a sensor unit including a sensor having an output value equal to or greater than a predetermined value, among the plurality of sensor units; and
the changing including, when the output values of all the sensors included in the first sensor unit become less than the predetermined value, changing the determination threshold value from the second value to the first value.

6. The steering apparatus according to claim 1, wherein
the steering wheel includes: a hub portion; a grip portion having a pair of left and right vertical portions extending substantially in an up-down direction on left and right sides of the hub portion and a horizontal portion extending substantially in a left-right direction below the hub portion and connecting the pair of left and right vertical portions; and spoke portions connecting the pair of left and right vertical portions to the hub portion, and
the plurality of sensor units are arranged in the vicinity of functional switch units respectively provided on left and right portions of the hub portion for vehicle information operation or driving assistance function operation.

7. The steering apparatus according to claim 1, wherein
the microprocessor is further configured to perform, when the water-exposed detection target region is specified, predicting that the detection target region of the second sensor unit located in a vicinity of the first sensor unit is exposed to water in the future when the output value of the second sensor unit gradually increases.

8. The steering apparatus according to claim 1, further comprising
a steering angle sensor configured to detect a steering angle of the steering wheel, wherein
the microprocessor is further configured to perform, when the steering angle detected by the steering angle sensor changes by an angle equal to or greater than a predetermined angle from a time point when the first sensor unit is specified as the water-exposed detection target region, in a case where the second sensor unit is located on a side opposite to the first sensor unit in a steering direction of the steering wheel, predicting that the detection target region of the second sensor unit is exposed to water in the future.

9. The steering apparatus according to claim 7, further comprising
a torque sensor for detecting steering torque acting on a shaft of the steering wheel, wherein
the microprocessor is configured to perform
the determination including, when an output value of any of the plurality of sensors included in the second sensor unit becomes equal to or greater than a predetermined value, after it is predicted that the detection target region of the second sensor unit is exposed to water in the future, determining whether or not the steering wheel is being gripped based on a detection value of the torque sensor.

10. The steering apparatus according to claim 9, wherein
the determination threshold value is a first determination threshold value,
each of the plurality of sensor units includes a plurality of capacitive sensors,
the output values of the plurality of sensor units include information on capacitance detected by the plurality of capacitive sensors,
the microprocessor is configured to perform the determining including determining that the steering wheel is being gripped when the detection value of the torque sensor is equal to or greater than a second determination threshold value, and
the second determination threshold value is set to a value smaller than the detection value of the torque sensor when the output values of the plurality of sensor units are the first value.
